(19) United States
(12) Patent Application Publication
(10) Pub. No.: US 2024/0142057 A1
(43) Pub. Date: May 2, 2024

(54) DEVICE FOR COMPRESSING A FLUID STORED IN THE FORM OF A CRYOGENIC LIQUID, AND ASSOCIATED MANUFACTURING METHOD

(71) Applicant: CYCLAIR, PRESSAC (FR)

(72) Inventor: GORRY Sébastien, PRESSAC (FR)

(21) Appl. No.: 18/547,177

(22) PCT Filed: Feb. 22, 2022
(86) PCT No.: PCT/FR2022/050322

§ 371 Date: Aug. 21, 2023

(30) Foreign Application Priority Data
Feb. 22, 2021 (FR) FR2101698

(51) Int. Cl. F17C 9/02; F17C 13/00

(52) U.S. Cl. CPC F17C 9/02; F17C 13/001; F17C 2201/0109; F17C 2203/0304; F17C 2205/0149; F17C 2209/2181; F17C 2223/036; F17C 2227/0304; F17C 2227/0323; F17C 2250/0626

(57) ABSTRACT

A device for compressing a fluid, such as dihydrogen, dioxygen, dinitrogen or argon, including: a cryogenic vessel capable of containing the fluid in liquid form at a cryogenic temperature, and fluid in the form of gas originating from a vaporization of the liquid in the cryogenic vessel; a pressure vessel surrounding the cryogenic vessel, configured to withstand an inner pressure; and a device for equalizing the pressure between the interior of the cryogenic vessel and the interior of the pressure vessel, the equalization device including a piping configured to transfer overpressurized gas into the cryogenic vessel in a space comprised between the pressure vessel and the cryogenic vessel, the piping including a device for reheating the overpressurized gas originating from the cryogenic vessel up to a predetermined temperature higher than the cryogenic temperature.

### CROSS REFERENCE TO RELATED APPLICATIONS

This application is a National Stage of International Application No. PCT/FR2022/050322, having an International Filing Date of 22 Feb. 2022, which designated the United States of America, and which International Application was published under PCT Article 21(2) as WO Publication No. 2022/175636 A1, which claims priority from and the benefit of French Patent Application No. 2101698 filed on 22 Feb. 2021, the disclosures of which are incorporated herein by reference in their entireties.

### FIELD

### Background

The field of the disclosure is that of the storage of a gas.

More specifically, the disclosure relates to a device for compressing a fluid stored in the form of a cryogenic liquid and an associated manufacturing method.

In particular, the disclosure finds applications for the storage of dihydrogen in order to power an electric vehicle, or for the storage of other fluids such as dioxygen, dinitrogen, argon or methane.

### Brief Description of Related Developments

Techniques for storing a pressurized gas in the form of cylinders stored in a rack are known from the prior art. Each cylinder, most often made of steel or aluminum, generally stores a given amount of gas at a maximum pressure in the range of 200 to 300 bar. Yet, in particular for dihydrogen, it is commonly accepted that an optimum storage pressure is in the range of 700 bar. Cylinders made of a composite with a carbon fiber structure are then used.

In order to obtain such a pressure level, it is consequently necessary to use a complex mechanical compressor, in particular to fill a tank of a vehicle at a pressure higher than the pressure of the cylinders.

Furthermore, storage techniques in the form of bottles in a rack have the drawback of being bulky. Moreover, a complex management of the fleet of cylinders is generally set up in order to regularly handle the bottles to replace them in order to enable the storage to have enough pressure to supply a tank of a proximate vehicle.

In order to reduce the bulk and transportation of the gas, techniques have been developed allowing storing the gas in liquid form, generally at cryogenic temperatures.

In general, such techniques comprise a cryogenic tank the insulation of which is performed for a vacuum vessel surrounding the inner vessel of the tank.

The drawback of these techniques is that the gas in liquid form tends to vaporize under the effect of the thermal inputs inherent to any cryogenic device. Thus, in order to avoid the pressure stresses exceeding the acceptable mechanical stresses for a material subjected to a cryogenic temperature, a safety valve is generally set up to limit the pressure inside the enclosure. The generally acceptable pressure for such enclosures is lower than 10 bar.

Indeed, it should be pointed out that the material used for cryogenic vessels is most often a metallic material offering mechanical characteristics suited for low temperatures, i.e. temperatures lower than −20° C. Furthermore, tanks made of a composite material, such as those comprising carbon fiber, are barely suited to low temperatures because they generally do not withstand the mechanical stresses associated with the pressure at these temperatures.

An example of a technique of the prior art relating to a cryogenic fluid storage tank is described in particular in the French patent application published under the number FR3089600.

None of the current systems allows simultaneously meeting all of the required needs, namely offering a technique that allows storing a high density of gas in a compact form, and offering a significant gas compression, which could range up to 700 or 800 bar, without the use of a complex mechanical device.

### SUMMARY

The present disclosure aims to remedy all or some of the above-mentioned drawbacks of the prior art.

To this end, the disclosure relates to a device for compressing a fluid, such as dihydrogen, dioxygen, dinitrogen or argon, comprising
a cryogenic vessel, capable of containing the fluid in liquid form at a cryogenic temperature, and fluid in the form of gas originating from a vaporization of the liquid in the cryogenic vessel;
a pressure vessel surrounding the cryogenic vessel, configured to withstand an inner pressure;
a device for equalizing the pressure between the interior of the cryogenic vessel and the interior of the pressure vessel, the equalization device comprising a piping configured to transfer overpressurized gas into the cryogenic vessel in a space comprised between the pressure vessel and the cryogenic vessel, the piping comprising a device for reheating the overpressurized gas originating from the cryogenic vessel, up to a predetermined temperature higher than the cryogenic temperature.

Thus, the fluid may be compressed to a high pressure without using a complex mechanical device by reinjecting the overpressurized gas originating from the vaporization of the cryogenic liquid contained in the cryogenic vessel.

Furthermore, in order to avoid deterioration of the cryogenic vessel under the effect of the pressure, the cryogenic vessel is advantageously immersed in a pressurized environment in which the pressure is equalized between the interior and the exterior of the cryogenic vessel. Thus, the pressure stresses are transferred to the pressure vessel which surrounds the cryogenic vessel.

Moreover, the temperature of the pressurized vessel is operating preferably higher than −20° C. in order to guarantee the mechanical strength of the pressurized vessel at high pressures the maximum value of which is for example in the range of 100 at 800 bar.

It should be pointed out that the compression device is not intended to store the fluid over a long period of time but is rather intended to be inserted into a storage system comprising a cryogenic tank storing the fluid in liquid form and a final storage tank. In this storage system, the compression device corresponds to an intermediate stage allowing feeding the final storage tank with a compressed gas resulting from the vaporization of part of the cryogenic liquid previously stored in the cryogenic tank. Afterwards, the compressed gas may be used to feed, for example, a tank of a vehicle provided with a fuel cell to generate electricity powering an electric motor of the vehicle.

In particular aspects of the disclosure, the gas reheating device is a heat exchanger placed outside the pressure vessel.

The heat exchanger may be of the gas/gas or gas/fluid type in order to reheat the gas extracted from the cryogenic vessel up to a temperature suited for the pressure vessel. Such a suited temperature may be determined according to the stresses admissible by the pressure vessel at the selected operating pressure.

The shape and type of the heat exchanger are determined according to the power to be extracted and the inlet and outlet temperatures of the exchanger.

Alternatively or complementarily to the heat exchanger, the reheating device comprises a thermal resistance inserted in the piping. The thermal resistance may be placed inside or outside the pressure vessel.

In particular aspects of the disclosure, the compression device includes a conduit for feeding in fluid in liquid form into the cryogenic vessel, the conduit passing through the walls of the pressure vessel and of the cryogenic vessel, the piping of the equalization device comprising:
a conduit for extracting overpressurized gas, passing through the pressure vessel and the cryogenic vessel in the direction of an inlet of the reheating device;
an equalization conduit, passing through the pressure vessel and opening out between the pressure vessel and the cryogenic vessel, the equalization conduit being connected to an outlet of the reheating device.

In particular aspects of the disclosure, the compression device also comprises a heating device inside the cryogenic vessel configured to vaporize the fluid in liquid form with a predetermined energy flow.

Thus, it is possible to increase the flow rate of gas extracted from the cryogenic vessel and to control this amount of gas. It should be pointed out that the flow rate of gas extracted from the vessel cannot be lower than the natural vaporization rate of the cryogenic liquid under the effect of the flow of energy input passing through the walls of the cryogenic vessel. Indeed, the insulation of the cryogenic vessel is configured to minimize this flow of energy input in a pressurized environment, which excludes the use of a vacuum vessel which would allow further reducing the flow of energy input by minimizing the thermal bridges towards the interior of the cryogenic vessel. Furthermore, to the extent that the compression device corresponds to an intermediate stage of the storage system, the quality of the insulation of the cryogenic vessel of the compression device is barely important in the operation of the compression device. Nevertheless, the insulation of the cryogenic vessel is configured to avoid an excessively low temperature in the pressure vessel.

In particular aspects of the disclosure, the heating device comprises an electrical resistance and/or a conduit for the circulation of a heat-transfer fluid.

In particular aspects of the disclosure, the pressure vessel and the cryogenic vessel are generally cylindrical in shape around the same axis of revolution.

In particular aspects of the disclosure, the pressure vessel is essentially formed of a metallic material, and configured to withstand a maximum inner pressure comprised between 100 and 800 bar.

In particular aspects of the disclosure, the cryogenic vessel comprises a layer of an insulating solid material withstanding the cryogenic temperatures and the fluid.

In particular aspects of the disclosure, the insulating solid material is polychlorotrifluoroethylene (PTCFE).

The disclosure also relates to a method for manufacturing a compression device according to any one of the previous aspects, the manufacturing method comprising steps of:
shaping the pressure vessel into a cylindrical shape closed at one end;
inserting the cryogenic vessel inside the pressure vessel;
inserting a protective material in a liquid form between the pressure vessel and the cryogenic vessel, the protective material hardening;
shaping a constriction at the open end of the pressure vessel after hardening of the protective material;
dissolving and extracting the protective material;
closing the pressure vessel in a sealed manner.

Thus, thanks to the presence of the protective material, it is possible to shape the pressure vessel of the compression device without damaging the cryogenic vessel which is generally more fragile because it is essentially made of a material tending to degrade under the effect of heat.

In particular implementations of the disclosure, a reflective material is inserted before the step of shaping the constriction in order to protect the cryogenic vessel from thermal radiation.

In particular implementations of the disclosure, the step of shaping a constriction is performed by deforming the open end.

In particular implementations of the disclosure, the deformation is performed by forging.

In particular implementations of the disclosure, the step of shaping a constriction is performed by securing a part.

In particular implementations of the disclosure, the manufacturing method comprises a step of inserting a plug before the step of shaping a constriction, the plug allowing closing the pressure vessel in a sealed manner.

In particular implementations of the disclosure, the manufacturing method comprises a step of threading the constriction of the open end of the pressure vessel, the thread being configured to fit with a thread of the plug.

In particular implementations of the disclosure, shaping of the pressure vessel is performed by forging.

In particular implementations of the disclosure, the manufacturing method comprises a step of adding an external reinforcing layer made of a composite material.

Advantageously, this addition step may be performed by winding at least one strip of fiber, preferably carbon, coated with resin around the pressure vessel.

In particular implementations of the disclosure, the protective material is a mixture of a granular material and of a liquid resin.

The disclosure also relates to an alternative method for manufacturing a compression device according to any one of the previous aspects, comprising steps of:
shaping a skeleton of the pressure vessel into a cylindrical shape;
inserting the cryogenic vessel inside the skeleton of the pressure vessel;
coating the skeleton of the pressure vessel by winding at least one strip of fiber coated with resin;
closing the pressure vessel in a sealed manner.

The disclosure also relates to a system for storing a fluid, such as dihydrogen, dioxygen, dinitrogen or argon, comprising:
a cryogenic tank storing the fluid in liquid form at a pressure lower than 10 bar and at a temperature lower than −150° C.;
a tank device according to any one of the previous aspects, fed by the cryogenic tank;
a reservoir for storing a pressurized gas, configured to withstand a maximum inner pressure comprised between 100 and 800 bar.

Finally, the disclosure also relates to a method of compressing a fluid stored in liquid form in a cryogenic tank of said storage system, comprising steps of:
filling the cryogenic vessel of the compression device of said storage system with fluid in liquid form at a cryogenic temperature;
closing the circuit between the cryogenic tank and the compression device;
vaporizing the fluid in liquid form into a gas;
naturally and continuously extracting the overpressurized gas in the cryogenic vessel;
reheating the extracted gas up to a temperature higher than −20° C.;
increasing the pressure in the compression device by reinjection of the reheated gas into a space between the pressure vessel and the cryogenic vessel.

In particular aspects of the disclosure, the compression method comprises a step of diverting the overpressurized gas when the pressure inside the compression device is higher than a predetermined value, the diverted gas being transferred into the storage tank of a pressurized gas of the storage system.

In particular aspects of the disclosure, the compression method also comprises a step of emptying part of the gas from the compression device, in order to lower the inner pressure of the compression device to a value lower than the pressure of the cryogenic tank, prior to a new filling of the cryogenic vessel of the compression device with fluid in liquid form at a cryogenic temperature originating from the cryogenic tank.

### BRIEF DESCRIPTION OF THE FIGURES

Other advantages, aims and particular features of the present disclosure will appear from the following non-limiting description of at least one particular aspect of the devices and methods objects of the present disclosure, with reference to the appended drawings, wherein:

FIG. 1 is a perspective view of a storage system comprising an aspect of the compression device according to the disclosure;

FIG. 2 is a sectional view of the compression device of FIG. 1;

FIG. 3 is a block view of an implementation mode of a method for manufacturing the compression device of FIG. 1;

FIG. 4 comprises five successive views illustrating the manufacturing method of FIG. 3;

FIG. 5 is a block view of an implementation mode of a compression method implementing the system of FIG. 1;

FIG. 6 comprises two sectional views of another aspect of a compression device that can be inserted into the storage system of FIG. 1;

FIG. 7 is a block view of an implementation mode of a method for manufacturing the compression device of FIG. 6.

### DETAILED DESCRIPTION

This description is given on a non-limiting basis, each feature of an aspect may advantageously be combined with any other feature of any other aspect.

It should be noted, as of now, that the figures are not to scale.

### Example of a Particular Aspect

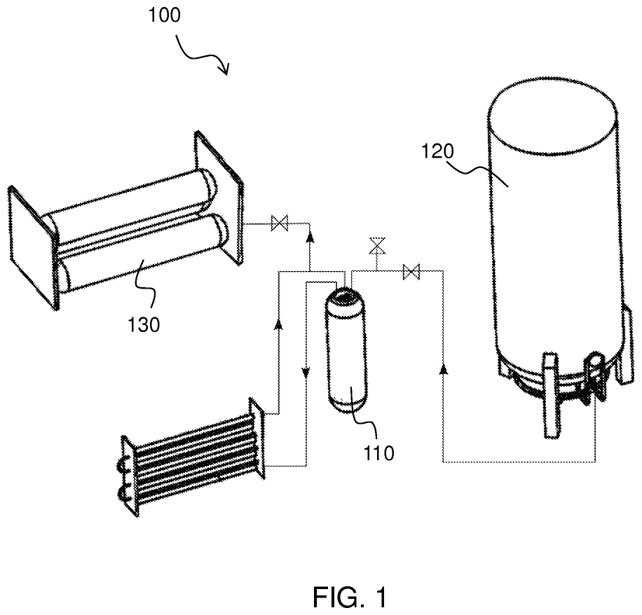

FIG. 1 is a perspective view of a storage system 100 comprising a compression device 110 according to the disclosure.

The compression device 110 corresponds to an intermediate stage between a cryogenic tank 120 storing a fluid in the form of a liquid and a second tank 130 storing the fluid in the form of a pressurized gas, for example, in order to feed a tank of a vehicle (not shown in FIG. 1).

In the present non-limiting aspect of the disclosure, the fluid is dihydrogen (H₂) used to supply a fuel cell of the vehicle whose drive motor is electric. The present disclosure may also be applied to storage of other fluid types, such as dinitrogen (N₂), dioxygen (O₂), argon (Ar) or methane (CH₄) by adapting, where necessary, the dimensions and the operating conditions which are described hereinafter.

Preferably, the present disclosure applies to fluids whose liquid/gas phase change temperature is lower than 120 K (i.e. about −150° C.).

For clarity, the fluid in liquid form is hereinafter called cryogenic liquid and the fluid in gaseous form is called gas.

The compression device 110 allows on the one hand vaporizing the cryogenic liquid originating from the cryogenic tank 120 where it is stored for example at 10 bar and at a temperature of 3 K (i.e. −270° C.), and on the other hand compressing the obtained gas without the use of complex mechanical parts at pressures in the range of 300 to 800 bar.

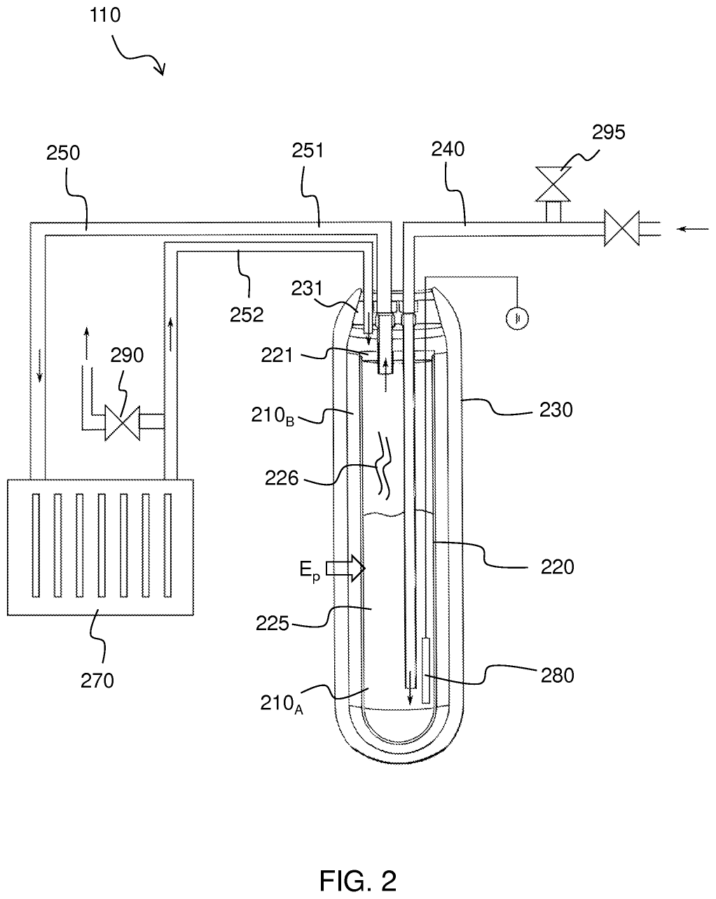

To this end, as shown in more detail in FIG. 2 which is a sectional view of the compression device 110, the compression device 110 is primarily composed of two vessels 210 formed by an inner cryogenic vessel 220 and by an outer pressure vessel 230 surrounding the cryogenic vessel 220. The cryogenic vessel 220 and the pressure vessel 230 generally have a cylindrical shape around the same axis of revolution 235.

The cryogenic vessel 220 is intended to contain a predetermined amount of cryogenic liquid 225 which has been transferred from the cryogenic reservoir 120 through a conduit 240. The conduit 240 passes through the walls of the pressure vessel 230 and of the cryogenic vessel 220, through plugs 231 and 221, and opens into a lower portion of the cryogenic vessel 220 in order to limit the evaporation of the cryogenic liquid during the filling phase.

During this filling phase, part of the cryogenic liquid 225 vaporizes initially with a high flow rate, in particular in a phase of heating up the cryogenic vessel 220, then with a lower flow rate when the temperature of the cryogenic vessel 220 has stabilized. The flow rate then corresponds to the flow of energy E p passing through the cryogenic vessel 220 by conduction whose structure is not optimized to store the cryogenic liquid over a long period of time but configured only to contain the cryogenic liquid 225 during its vaporization phase.

The gas 226 obtained by vaporization of the cryogenic liquid 225 will tend to increase the pressure of the cryogenic vessel 220. In order to avoid deformation of the cryogenic vessel and enable an increase in the pressure within the compression device 110, the compression device 110 comprises a device 250 for equalizing the pressure between the chamber 210A inside the cryogenic vessel 220 and the chamber 210_{B} between the pressure vessel 230 and the cryogenic vessel 220.

The pressure equalization device 250 comprises piping configured to transfer overpressurized gas into the cryogenic vessel 220 in a space comprised between the pressure vessel 230 and the cryogenic vessel 220, namely herein in the chamber 210_{B} whose volume is equal to the internal volume of the pressure vessel 230 from which the volume of the cryogenic vessel 220 is subtracted.

Advantageously, the piping of the pressure equalization device 250 comprises a device 270 for reheating the gas originating from the cryogenic vessel 220, up to a predetermined temperature higher than the cryogenic temperature. For example, the predetermined temperature may be equal to 250 K (about −20° C.), at room temperature, or at any other temperature comprised between 250 K and room temperature.

Preferably, the gas reheating device 270 is a heat exchanger placed outside the pressure vessel 230, as illustrated in FIG. 2. The heat exchanger is configured to allow reheating the gas originating from the cryogenic vessel 220 on average up to the predetermined temperature. The heat exchanger may be of the gas/gas or gas/liquid type, and is configured to withstand high pressures. The advantage of the heat exchanger is to have zero impact on the energy balance of the operation of the compression device 110, the gas moving naturally between the two vessels of the compression device 110, throughout the heat exchanger.

For example, the heat exchanger may consist of projecting fins around the piping or with a more complex shape capable of withstanding the pressure such as a tube exchanger.

Alternatively or complementarily, the gas reheating device 270 may be a heating resistance.

The piping of the pressure equalization device 250 comprises a duct 251 for extracting the overpressurized gas, passing through the pressure vessel 230 and the cryogenic vessel 220 in the direction of an inlet of the gas reheating device 270.

The piping of the pressure equalization device 250 also comprises an equalization conduit 252 allowing returning the gas extracted from the cryogenic vessel 220 into the chamber 210_{B}. To this end, the equalization conduit 252 is connected to an outlet of the gas reheating device 270, passes through the pressure vessel 230 and opens out between the pressure vessel 230 and the cryogenic vessel 220.

Thus, the chamber 210_{B} stores gas under pressure at a temperature in the range of 250 K while the chamber 210A stores fluid at a cryogenic temperature.

The vaporization flow of the cryogenic liquid in the cryogenic vessel 220 corresponds at most to the flow of thermal energy E p passing through the walls. The vaporization flow may be increased by an energy input performed for example by means of a heating device 280 inserted inside the cryogenic vessel 220. This energy input, which may be varied automatically or manually by an operator, allows adjusting the vaporization flow of the cryogenic liquid.

For example, the heating device 280 may be composed of an electrical resistance and/or a conduit for the circulation of a heat-transfer fluid.

The pressure vessel 230 is essentially formed of a metallic material, thereby enabling a configuration of the vessel to withstand a maximum inner pressure in the range of 800 bar.

In turn, the cryogenic vessel 220 is essentially formed, in the present non-limiting example of the disclosure, in an insulating solid material withstanding the cryogenic temperatures. Advantageously, the insulating solid material used for the cryogenic vessel 220 is inert to the contained fluid.

Here, the used insulating solid material is polychlorotrifluoroethylene (PTCFE), conferring good mechanical properties in terms of insulation and resistance of the materials to cryogenic temperatures.

Nonetheless, it should be pointed out that the cryogenic vessel 220 formed in such an insulating material tends to deteriorate when the inner pressure is higher by 5 or 10 bar with respect to the external pressure. Its main role is then to provide a container suited for the temporary storage of the cryogenic liquid originating from the cryogenic tank 120, during the phase of isochoric compression of the gas resulting from the vaporization of the cryogenic liquid, while minimizing thermal losses in order to best adjust the amount of gas produced by vaporization of the cryogenic liquid.

When the target pressure is reached in the compression device 110, a valve 290 is opened in order to transfer pressurized gas into the storage tank 130.

Advantageously, a valve 295 for emptying the compression device 110 may be comprised in the circuit in order to lower the inner pressure of the compression device 110 to a value lower than the pressure of the cryogenic reservoir 120, prior to a new filling of the cryogenic vessel 220 of the compression device 110 with cryogenic liquid originating from the cryogenic tank 120.

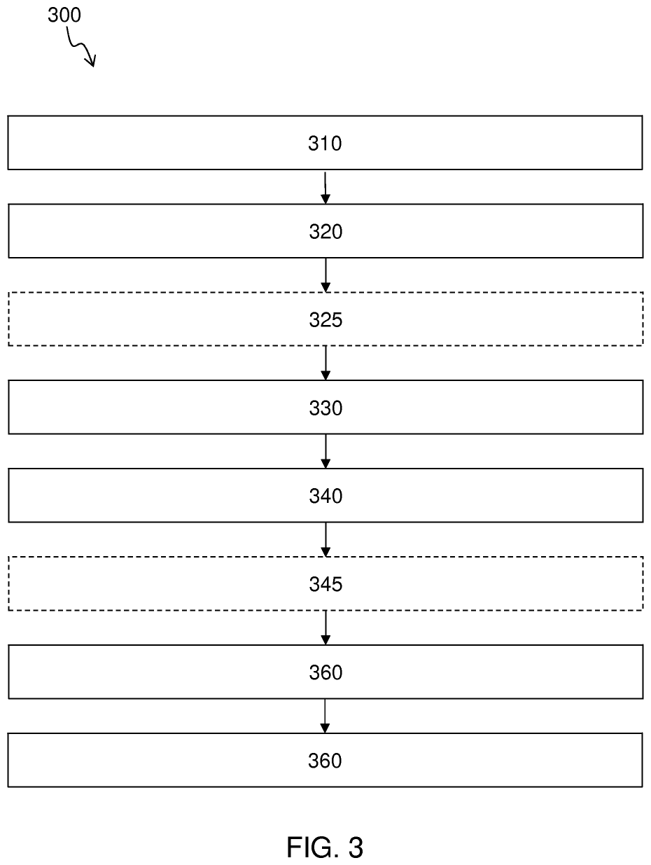

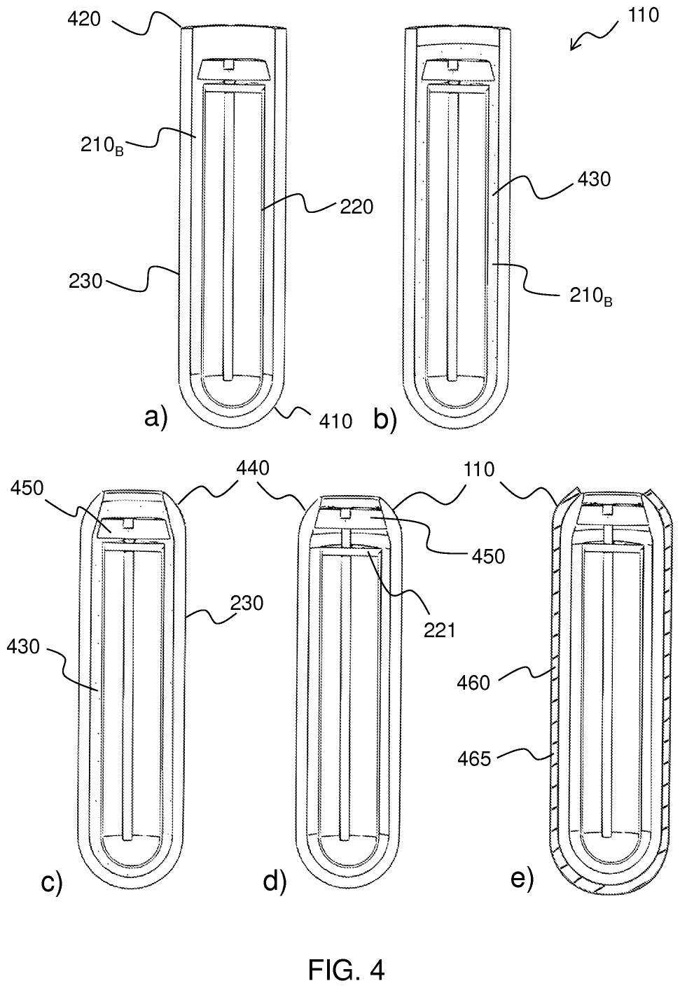

FIG. 3 is a block view of an example of implementation of a method 300 for manufacturing the compression device 110 according to the disclosure. FIG. 4 illustrates in a schematic form the progress of the manufacture of the compression device 110.

The manufacturing method 300 comprises a first step 310 of shaping the pressure vessel 230 into the general shape of a longilineal cylinder 400 closed at one end 410, the other open end 420 being initially left straight to enable the insertion of the cryogenic vessel 220 during a second 320 of the manufacturing method 300, as illustrated by sub-figure a) of FIG. 4. The shaping of the first step 310 may be performed for example by a conventional boilermaking technique starting from a pipe or a disc deformed by a press.

In order to maintain and protect the cryogenic vessel 220, a protective material 430 is inserted in liquid form into the chamber 210_{B} between the pressure vessel 230 and the cryogenic vessel 220 during a third manufacturing step 330, as illustrated in sub-figure b) of FIG. 4. The protective material, which is for example a mixture of a resin and a granular material such as sand, will harden after insertion thereof into the chamber 210_{B}.

To this end, the protective material may have been heated beforehand to fluidize it, thereby enabling insertion thereof into the chamber 210_{B}. Upon cooling thereof, the protective material will harden matching with the shape of the chamber 210_{B}.

As illustrated by sub-figure c) of FIG. 4, a shaping of a constriction 440 of the open end 420 of the pressure vessel 230 is performed afterwards during the fourth step 340 of the manufacturing method 300, after the protective material has hardened.

This shaping may be performed by deformation of the open end 420, for example by a forging technique, or by securing a complementary part with an adequate shape. Securing the complementary part may be performed by brazing or welding.

In both cases, the pressure vessel 230 is locally heated up to a temperature high enough to be likely to irreversibly damage the cryogenic vessel 220. Nonetheless, the prior insertion of the protective material during step 330 allows minimizing the rise in temperature of the cryogenic vessel 220 during step 340 of shaping the constriction of the open end of the pressurized enclosure 230.

It should be pointed out that the thickness of the pipe used to shape the pressure vessel 230 generally corresponds to that defined by the “schedule 160” type so that the ratio between the thickness and the diameter is high enough to withstand the mechanical stresses due to the nominal pressure of 700 to 800 bar. In order to be able to use pipes with a smaller thickness, like “schedule 80” for example, which is more suited for the forging operation, a reinforcement by adding an external layer 460 of composite material may be considered during an optional step 345. As illustrated in sub-figure e) of FIG. 4, the external layer 460 of composite material may for example be made by winding at least one strip 465 of carbon fiber coated with resin.

Complementarily or alternatively to the protective material, a reflective material such as a screen may be inserted before the shaping step 340, in order to protect the cryogenic vessel 220 from the thermal radiation induced during the shaping step.

Afterwards, the protective material 430 is dissolved and extracted from the compression device 110 during a fifth step 350 of the manufacturing method 300.

The compression device 110 is completed by closing the pressurized vessel 230 in a sealed manner during a sixth step 360 of the manufacturing method 300, as illustrated in sub-figure d) of FIG. 4.

Preferably, a plug 450 with a frustoconical shape allowing closing the pressure vessel, is inserted before step 340 of shaping the constriction 440 during an optional step 325 of the manufacturing method 300, for example just after the insertion of the cryogenic vessel 220. The plug 450 is threaded complementarily with a thread of the constriction 440 of the open end 420, formed beforehand.

Alternatively, a cylindrical shaped plug is inserted into the constriction 440 and secured to the constriction by a welding or brazing technique. In this case, the protective material 430 is advantageously retained, steps 350 and 360 of the manufacturing method being possibly reversed.

Indeed, it should be pointed out that in both cases the plugs have open-through holes, preferably threaded in order to let the different conduits 240, 251 and 252 pass through previously installed cable-glands. Thus, the protective material 430 may be extracted from the chamber 210_{B} through the open-through hole provided for the equalization duct 252.

The cryogenic vessel 220 is held in position inside the pressure vessel 230 through the cable-glands sealingly tightening the conduits 240 and 251 when they pass through the plugs 221 and 450 of each vessel.

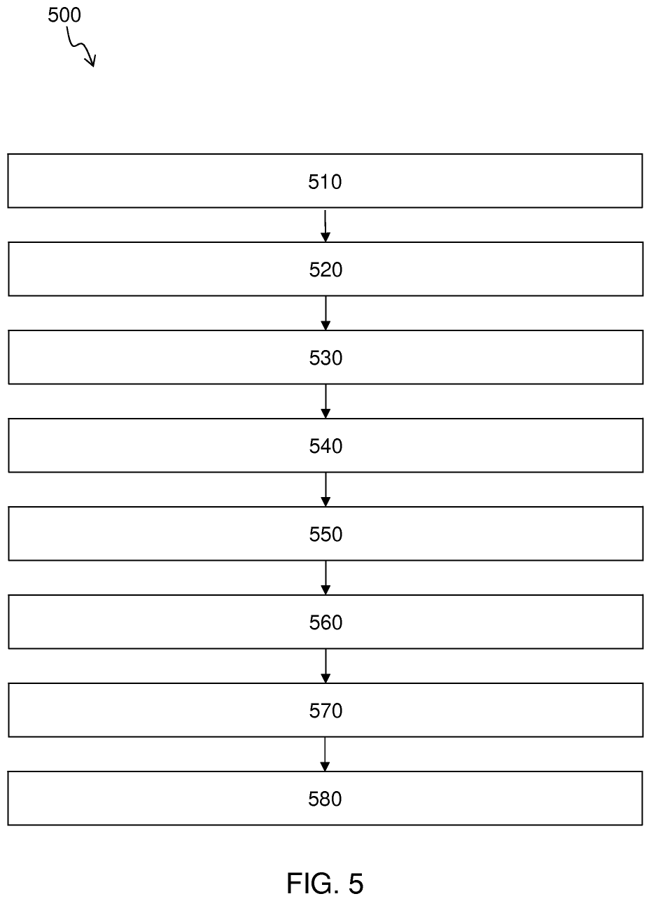

FIG. 5 shows a synoptic view of a mode of implementation of a method 500 for compressing the fluid stored in the form of cryogenic liquid in the cryogenic tank 120.

The compression method 500 comprises a first step 510 of filling the cryogenic vessel 220 of the compression device 110 with cryogenic liquid through the feed-in conduit 240.

Afterwards, the feed-in conduit 240 between the cryogenic reservoir 120 and the compression device 110 is closed by the actuation of a valve 296 during a second step 520 of the compression method 500.

The cryogenic liquid vaporizes inside the cryogenic vessel during a third step 530 of the compression method 500. This vaporization may be increased by adding an energy input through the heating device 280 which preferably immerses into the cryogenic liquid.

Afterwards, the overpressurized gas above the cryogenic liquid in the cryogenic vessel 220 is extracted from the cryogenic vessel 220 via the extraction conduit 251 during a fourth step 540 of the compression method 500.

The extracted gas is reheated up to a temperature close to or higher than 250 K (about −20° C.) during a fifth step 550 before being reinjected into the pressure vessel 230, more specifically into the chamber 210_{B} comprised between the pressure vessel 230 and the cryogenic vessel 220, during a sixth step 560 of the compression method 500.

The reinjection of the gas contributes to increasing pressure within the compression device 110, the compression being performed isochorically.

It should be pointed out that the extraction of the overpressurized gas and the reinjection of the gas into the pressure vessel 230 is performed naturally and continuously, the pressure of gas tending to equalize within the compression device 110. More specifically, a natural equalization of the pressure is performed continuously between the two chambers 210 of the compression device 110, this equalization resulting in a transfer of gas which is reheated before reinjection.

When the target pressure is reached, part of the overpressurized gas is diverted by opening the valve 290 during a seventh step 570 of the compression method 500, in order to fill the gas storage tank 130 for use thereof.

It should be pointed out that the bypass may advantageously be performed in the circuit of the equalization device 250 after the gas has passed through the reheating device 270. Alternatively, the gas is diverted upstream of the reheating device 270. In this case, an auxiliary heating device is preferably installed on the pipe connecting the bypass of the equalization device 250 to the storage tank 130.

The method 500 may also comprise a step 580 of emptying part of the gas from the compression device 110, in order to lower the inner pressure of the compression device 110 to a value lower than the pressure of the cryogenic reservoir 120. The method 500 may then start again.

In the present non-limiting example of the disclosure, the cryogenic tank 120 has a volume in the range of 3,000 to 10,000 liters. In turn, the volume of the cryogenic vessel 220 is in the range of 100 to 300 liters. In general, the volume of the chamber 210_{B} is between two and five times larger, preferably three times larger, than that of the cryogenic vessel 220 in order to offer a high compression ratio. Indeed, it should be pointed out that the volumetric mass of the gas is generally one thousand times lower than that of the liquid, the vaporization of the liquid in a given volume consequently leads to a natural increase in the pressure, which is herein allowed on the one hand thanks to the presence of the pressure vessel 230 and on the other hand thanks to the equalization circuit allowing transferring the gas between the two enclosures 210 of the compression device 110 while reheating it to avoid a degradation of the mechanical strength of the pressure vessel 230.

In general, the volume of the storage reservoir 130 is three times larger than that of the chamber 210_{B}, composed for example of three sub-tanks with the same volume as that of the chamber 210_{B}. These three sub-tanks may be in different sub-circuits so that they could be filled or emptied individually.

### Another Exemplary Aspect

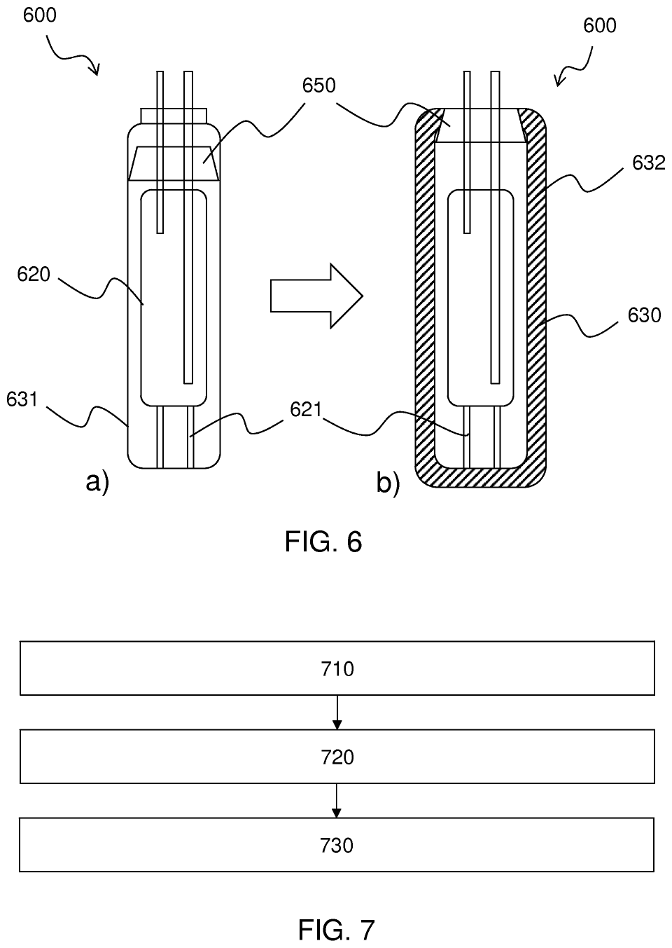

FIG. 6 illustrates another example of a compression device 600 according to the disclosure which has been made according to an alternative manufacturing method 700 illustrated in the block diagram in FIG. 7.

The compression device 600 differs from the compression device 100 of the previous aspect in that the pressure vessel 630 is composed of a metallic skeleton 631 with a generally cylindrical shape, replacing the pipe used during the manufacturing method 300, as illustrated in sub-figure a) of FIG. 6. The metallic structure 631 is wrapped by an external layer 632 made of a composite material maintaining the pressure, as illustrated in sub-figure b) of FIG. 6.

Advantageously, the cryogenic vessel 620 of the compression device 600 may comprise a plurality of legs 621 allowing holding the cryogenic vessel 620 during making of the compression device 600.

Thus, the manufacturing method 700 comprises a first step 710 of making the metallic skeleton 631 surrounding the cryogenic vessel 620 which may be positioned upstream or inserted when the metallic skeleton 631 is made.

Afterwards, the skeleton 631 of the pressure vessel 630 is wrapped by at least one strip of carbon fiber coated afterwards with resin in order to form the external layer 632. The thickness of the external layer 632 is configured to withstand the mechanical stresses due to the rated pressure of 700 to 800 bars. It should be pointed out that any other type of composite material, addressing the mechanical stresses, may be considered by a person skilled in the art.

Afterwards, the pressure vessel 630 may be closed by the plug 650, during a third step 730, in a manner similar to the manufacturing method 300, the plug 650 having been inserted beforehand inside the skeleton 631.

The other elements of the previous aspect are identical.

What is claimed is:

1. A device for compressing a fluid, such as dihydrogen, dioxygen, dinitrogen or argon, characterized in that it comprises:
a cryogenic vessel, capable of containing the fluid in liquid form at a cryogenic temperature, and fluid in the form of gas originating from a vaporization of the liquid in the cryogenic vessel;
a pressure vessel surrounding the cryogenic vessel, configured to withstand an inner pressure;
a device for equalizing the pressure between the interior of the cryogenic vessel and the interior of the pressure vessel, the equalization device comprising a piping configured to transfer overpressurized gas into the cryogenic vessel in a space comprised between the pressure vessel and the cryogenic vessel, the piping comprising a device for reheating the overpressurized gas originating from the cryogenic vessel, up to a predetermined temperature higher than the cryogenic temperature.

2. The compression device according to claim 1, wherein the gas reheating device is a heat exchanger placed outside the pressure vessel.

3. The compression device according to claim 1, comprising a conduit for feeding in fluid in liquid form into the cryogenic vessel, the conduit passing through the walls of the pressure vessel and of the cryogenic vessel, and wherein the piping of the equalization device comprises:
a conduit for extracting overpressurized gas, passing through the pressure vessel and the cryogenic vessel in the direction of an inlet of the reheating device;
an equalization conduit, passing through the pressure vessel and opening out between the pressure vessel and the cryogenic vessel, the equalization conduit being connected to an outlet of the reheating device.

4. The compression device according to claim 1, also comprising a heating device inside the cryogenic vessel configured to vaporize the fluid in liquid form with a predetermined energy flow.

5. The compression device according to claim 4, wherein the heating device comprises an electrical resistance and/or a conduit for the circulation of a heat-transfer fluid.

6. The compression device according to claim 1, wherein the pressure vessel and the cryogenic vessel are generally cylindrical in shape around the same axis of revolution.

7. The compression device according to claim 1, wherein the pressure vessel is essentially formed of a metallic material, and configured to withstand a maximum inner pressure comprised between 100 and 800 bar.

8. The compression device according to claim 1, wherein the cryogenic vessel comprises a layer of an insulating solid material withstanding the cryogenic temperatures and the fluid.

9. The compression device according to claim 8, wherein the insulating solid material is polychlorotrifluoroethylene.

10. A method for manufacturing a compression device according to claim 1, characterized in that it comprises steps of:
shaping the pressure vessel into a cylindrical shape closed at one end;
inserting the cryogenic vessel inside the pressure vessel;
inserting a protective material in a liquid form between the pressure vessel and the cryogenic vessel, the protective material hardening;
shaping a constriction at the open end of the pressure vessel after hardening of the protective material;
dissolving and extracting the protective material;
closing the pressure vessel in a sealed manner.

11. The manufacturing method according to claim 10, wherein a reflective material is inserted before the step of shaping the constriction in order to protect the cryogenic vessel from thermal radiation.

12. The manufacturing method according to claim 10, wherein the step of shaping a constriction is performed by deforming the open end.

13. The manufacturing method according to claim 12, wherein the deformation is performed by forging.

14. The manufacturing method according to claim 10, wherein the step of shaping a constriction is performed by securing a part.

15. The manufacturing method according to claim 10, also comprising a step of inserting a plug before the step of shaping a constriction, the plug allowing closing the pressure vessel in a sealed manner.

16. The manufacturing method according to claim 15, also comprising a step of threading the constriction of the open end of the pressure vessel, the thread being configured to fit with a thread of the plug.

17. The manufacturing method according to claim 10, comprising a step of adding an external reinforcing layer made of a composite material.

18. The manufacturing method according to claim 10, wherein the protective material is a mixture of a granular material and of a liquid resin.

19. A method for manufacturing a compression device according to claim 1, characterized in that it comprises steps of:
shaping a skeleton of the pressure vessel into a cylindrical shape;
inserting the cryogenic vessel inside the skeleton of the pressure vessel;
coating the skeleton of the pressure vessel by winding at least one strip of fiber coated with resin;
closing the pressure vessel in a sealed manner.

20. A system for storing a fluid, such as dihydrogen, dioxygen, dinitrogen or argon, comprising:
a cryogenic tank storing the fluid in liquid form at a pressure lower than 10 bar and at a temperature lower than −150° C.;
a tank device according to claim 1, fed by the cryogenic tank;
a reservoir for storing a pressurized gas, configured to withstand a maximum inner pressure comprised between 100 and 800 bar.

21. A method of compressing a fluid stored in liquid form in a cryogenic tank of a storage system according to claim 20, comprising steps of:
filling the cryogenic vessel of the compression device of said storage system with fluid in liquid form at a cryogenic temperature;
closing the circuit between the cryogenic tank and the compression device;
vaporizing the fluid in liquid form into a gas;
extracting the overpressurized gas in the cryogenic vessel;
reheating the extracted gas up to a temperature higher than −20° C.;
increasing the pressure in the compression device by reinjection of the reheated gas into a space between the pressure vessel and the cryogenic vessel.

22. The compression method according to claim 21, also comprising a step of diverting the overpressurized gas when the pressure inside the compression device is higher than a predetermined value, the diverted gas being transferred into the storage tank of a pressurized gas of the storage system.

23. The compression method according to claim 21, also comprising a step of emptying part of the gas from the compression device, in order to lower the inner pressure of the compression device to a value lower than the pressure of the cryogenic tank, prior to a new filling of the cryogenic vessel of the compression device with fluid in liquid form at a cryogenic temperature originating from the cryogenic tank.
